(19) United States
(12) Patent Application Publication
(10) Pub. No.: US 2010/0221389 A1
(43) Pub. Date: Sep. 2, 2010

(54) Drinking Straw

(76) Inventors: Leo Gerardus Frenken, Vlaardingen (NL); Aafje Sierksma, Vlaardingen (NL); Nicolaas Jan Zuidam, Vlaardingen (NL)

Correspondence Address: UNILEVER PATENT GROUP, 800 SYLVAN AVENUE, AG West S. Wing, ENGLEWOOD CLIFFS, NJ, 07632-3100, US

(21) Appl. No.: 11/990,059

(22) PCT Filed: Jul. 28, 2006
(86) PCT No.: PCT/EP2006/007631

§ 371 Date: Feb. 5, 2008

(30) Foreign Application Priority Data
May 15, 2005 (EP) 05076887.8

(51) Int. Cl. A47G 21/18; A23L 1/304; A23L 2/52; B65D 77/28

(52) U.S. Cl. 426/74; 426/85; 426/390

(57) ABSTRACT

A combination of a container in which is disposed a liquid composition in the form of a beverage or liquid food and a drinking straw comprises a hollow elongate tube through which liquid may be drawn by suction. The tube has an outer surface and an inner surface. The combination includes an iron component and an oxidisable oil. The iron component is disposed inside the drinking straw and the oxidisable oil is in the liquid composition. The straw alone is also an aspect of the invention.

### FIELD OF THE INVENTION

The present invention relates to a drinking straw of the kind which comprises a substance to be ingested.

### BACKGROUND OF THE INVENTION

Recently, there has been interest in providing foods or food supplements containing micronutrients which include iron, e.g. in the form of one or more iron salts, and one or more ingredients such as vitamin C and polyunsaturated acids (including long chain polyunsaturated fatty acids). However, we have found that inclusion of an iron component in liquid products can have the drawback that they can result in storage instability of the product due to adverse interactions with oxidisable oil contained within the same liquid product, notably an oil containing polyunsaturated fatty acids. The oxidation of polyunsaturated fatty acids in a liquid product is greatly accelerated by the presence of an iron component and is accompanied by the generation of objectionable off-flavours.

We have now discovered that it is possible to deliver such iron-based micronutrient compositions to consumers via a liquid composition in the form of a liquid food product or a beverage, if the iron component and the oxidisable oil are kept separate, i.e. by disposing the iron component on the inside of a drinking straw and incorporating the oxidisable oil in the beverage or liquid food. Further, if the iron component is coated on the inside of the straw, its solubility can be controlled such that the perception of undesirable taste can be minimised for the consumer.

It is common to consume beverages through drinking straws. They comprise a hollow elongate tube which is open at either end. They are usually made of plastics and/or paper materials. One end of the straw is immersed in the beverage. The consumer places the other end in his or her mouth and draws up the beverage by suction. For reasons of hygiene and convenience, the straw is normally thrown away after a single use.

It is known to provide flavouring agents on the inner surface of a drinking straw to be diluted and consumed by a person drinking a beverage through the straw. This, for example, is disclosed in US-A-4 921 713.

It is also known to coat the inside of a drinking straw with a probiotic ingredient in the form of cells of Lactobacillus reuteri, as disclosed in US-A-6 283 294. It is also known to provide an edible drinking straw or other edible eating utensil which is fortified with nutritional supplements such as vitamins and minerals, as disclosed in US-A-2004/0013772.

### DEFINITION OF THE INVENTION

A first aspect of the present invention now provides a combination of a container in which is disposed a liquid composition in the form of a beverage or liquid food and a drinking straw comprising a hollow elongate tube through which liquid may be drawn by suction, the tube having an outer surface and an inner surface, the combination further comprising an iron component and an oxidisable oil containing one or more polyunsaturated fatty acids, wherein the iron component is disposed inside the drinking straw and the oxidisable oil is in the liquid composition.

A second aspect of the present invention provides a drinking straw comprising a hollow elongate tube through which liquid may be drawn by suction, the tube having an outer surface and an inner surface, an iron component being disposed inside the drinking straw.

A drinking straw according to the second aspect of the present invention may be provided for consumption of a liquid composition comprising an oxidisable oil.

### DETAILED DESCRIPTION OF THE INVENTION

In the most preferred embodiments, the iron component and the oxidisable oil containing one or more polyunsaturated fatty acids are kept substantially totally separate, i.e. one entirely inside the straw and the other entirely in the liquid composition. However, minor amounts of one or both of these components may be present with the other, i.e. in the liquid composition or inside the straw, as the case may be. In such cases, preferably no more than 20% by weight of either or both components may be so located, more preferably no more than 10%, still more preferably no more than 5%, yet more preferably no more than 1%.

The arrangement in which the iron component is disposed inside the drinking straw and the oxidisable oil is in the liquid composition offers the advantage that detrimental effects of the iron component on other ingredients of the liquid compositions, e.g. flavonoids, isoflavanes, polyphenols and anti-oxidant flavourings, is minimised. Furthermore, in this arrangement oxidisable oil may be protected effectively against oxidation by packaging it in a container that is impermeable to UV-radiation and that does not comprise an oxygen-containing headspace.

### The Iron Component

The iron component employed in accordance with the present invention may comprise elemental iron and/or one or more iron compounds, such as salts, especially water soluble salts. The most common iron salts or other compounds which can be delivered by this means may be selected from iron II sulphate, iron fumarate, iron III sulphate, iron pyrophosphate, iron lactate, ion citrate, iron ammonium citrate, iron ammonium sulphate, iron saccharate, iron glucomate, iron succinate, iron complexed with EDTA and mixtures thereof. In the foregoing list of iron salts, where the valency of the iron is not recited, it may be any valency in which the iron may exist in the salt in question. As stated above, elemental iron may also be delivered in this way, preferably in fine particle form, alone or in combination with one or more iron compounds such as salts.

The total amount of the iron component in a single drinking straw or drinking straw/container combination may be, for example, from 1 mg to 60 mg, preferably from 4 mg to 12 mg, more preferably from 5 mg to 7 mg. The amount of iron contained in a single straw or drinking straw/container combination may be 1 mg to 20 mg, preferably 2 to 12 mg.

According to a preferred embodiment, the iron component is coated on the inner surface of the drinking straw. Typically, the coating on the inner surface contains at least 3 wt. % of iron. Preferably, said coating contains at least 6 wt. % of iron. The amount of iron contained in the coating usually does not exceed 30 wt. %.

### Other Micronutrient Components

The present invention is also particularly beneficial in cases where at least one micronutrient additional to the iron component is delivered by means of the invention. That is to say, a micronutrient which is additional to the iron component. It may be incorporated in the liquid composition and/or inside the straw. Advantageously, the additional micronutrient(s) may comprise a metal other than iron and/or a compound thereof. For example, chromium, copper, zinc, compounds of any of these metals and mixtures thereof. Calcium magnesium, manganese, potassium and selenium, and compounds and/or mixtures thereof may also be present. Typical compounds are salts of these metals, such as chlorides, oxides, hydroxides, sulphates, phosphates, as well as salts of organic acids such as acetates, lactates, fumarates, succinates and gluconates. Mixtures of such salts are also possible. The metal(s) in question may adopt any suitable valency in such compounds.

The total amount of other metal(s) and/or compound(s) thereof may be, for example, from 1 μg to 3,500 mg, preferably from 5 μg to 2,000 mg, more preferably from 10 μg to 500 mg. When the other metal(s) and/or compounds thereof are incorporated solely in the beverage product or liquid food product rather than coated on the inside of the drinking straw, preferably their total inclusion level is from 0.000015 g/l (e.g. from 0.0000015% to 0.2% by weight of product) to 20 g/l, more preferably from 0.000029/1 to 5 g/l (e.g. from 0.000002% to 0.5% by weight of product).

In fact the desirable inclusion levels vary widely from one metal to another, as indicated by the following table:

| | | | | | More | | | | Especially | | | |
|---|---|---|---|---|---|---|---|---|---|---|---|---|
| | Preferred | | | | Preferred | | | | preferred | | | |
| Nutrient | Min | | Max | | Min | | Max | | Min | | Max | |
| Chromium | 1 | μg | 35 | μg | 5 | μg | 20 | μg | 10 | μg | 15 | μg |
| Copper | 1 | μg | 900 | μg | 100 | μg | 600 | μg | 200 | μg | 400 | μg |
| Zinc | 1 | mg | 20 | mg | 4 | mg | 10 | mg | 3 | mg | 5 | mg |
| Calcium | 1 | mg | 1300 | mg | 300 | mg | 600 | mg | 60 | mg | 90 | mg |
| Magnesium | 1 | mg | 270 | mg | 50 | mg | 100 | mg | 20 | mg | 40 | mg |
| Manganese | 1 | mg | 2.3 | mg | 1 | mg | 2 | mg | 1 | mg | 1.5 | mg |
| Potassium | 1 | mg | 3500 | mg | 1000 | mg | 2000 | mg | 400 | mg | 600 | mg |
| Selenium | 1 | μg | 35 | μg | 5 | μg | 15 | μg | 6 | μg | 8 | μg |

The beverage or liquid food and/or the coating on the inside of the straw may further comprise one or more non-metallic micronutrient ingredients, such as vitamins, eg. vitamin C, dietary fibre, polyphenols, as well as probiotic ingredients. As used herein, the term “probiotic ingredient” means an ingredient comprising live cells of one or more organisms (e.g. bacteria or yeast cells) having a beneficial effect on human metabolism.

### The Oxidisable Oil

The oxidisable oil comprising one or more polyunsaturated fatty acids preferably is a triglyceride oil. The content of oxidisable triglyceride oil comprising one or more polyunsaturated fatty acids equals the amount of triglycerides containing 1-3 polyunsaturated fatty acid residues.

The straw containing the iron component is intended for use in combination with a liquid food or beverage in a container, wherein the beverage contains the oxidisable oil. One particular oxidisable oil having an adverse interaction if stored in contact with the iron component comprises long chain polyunsaturated fatty acids, e.g. those having 10 or more carbon atoms in addition to those in the carboxylic acid group(s), such as C₁₀-C₂₂ fatty acids.

The oxidisable oil comprising one or more polyunsaturated fatty acids typically contains at least 10 wt. % polyunsaturated fatty acids, more preferably at least 10 wt. % of C₂₀-C₂₄ ω-3 polyunsaturated fatty acids. The latter ω-3 polyunsaturated fatty acids are extremely sensible to oxidation. Furthermore, the oxidation products of these fatty acids give off a very strong ‘fishy’ smell.

The total amount of polyunsaturated fatty acids contained in the drinking straw/container combination is typically from 50 mg to 20,000 mg, preferably from 200 mg to 12,000 mg, more preferably from 500 mg to 8,000 mg and most preferably from 2 mg to 7 mg by weight of the beverage. The total amount of C₂₀-C₂₄ 3 polyunsaturated fatty acids contained in a single drinking straw or drinking straw/container combination is typically from 1 mg to 100 mg, preferably from 1 mg to 10 mg and most preferably from 2 mg to 7 mg by weight of the beverage. The polyunsaturated fatty acids are preferably incorporated in the liquid food or beverage composition in an amount of from 0.001 g/l to 10 g/l, more preferably from 0.001 g/l to 0.1 g/l (e.g. from 0.0001% to 0.01% by weight of a product), even more preferably from 0.005 g/l to 0.075 g/l, (e.g. from 0.0005% to 0.0075% by weight of product). Typically, the amount of oxidisable oil contained in the liquid product is within the range 0.5-20 wt. %.

### Coating

According to a particularly advantageous embodiment of the invention, the iron component disposed inside the drinking straw is coated on the inner surface thereof. It was found that if the coating on the inner surface contains at least 0.5 wt. %, particularly at least 3 wt. % of lipid material, said coating will stick well to said inner surface. More preferably, the coating contains 5-60 wt. % of lipid material. Examples of lipid materials that may suitably be employed include triglycerides, waxes, sucrose fatty acid esters, fatty acid emulsifiers and combinations thereof. The term ‘fatty acid emulsifiers’ refers to substances that contain one or more fatty acid residues as well as at least on hydrophilic residue. Examples of fatty emulsifiers include, monoglycerides, diglycerides, esters of monoglycerides, esters of diglycerides and phospholipids. Preferably, the lipid material is selected from the group consisting of triglycerides; waxes; hexa-, hepta- or octa-esters of sucrose and fatty acids; and combinations thereof.

It is strongly preferred to employ in the coating on the inner surface a lipid material with a low iodine value, i.e. a lipid material containing a low level of unsaturated fatty acids. Thus, the risk of iron catalysed formation of lipid oxidation products is minimised. Preferably, the lipid material has an iodine value of not more than 50, more preferably of not more than 30, even more preferably of not more than 15 and most preferably of not more than 5. Furthermore, it is preferred to employ a lipid material with a melting point of at least 30° C. By employing a lipid material that contains a substantial amount of solid fat at room temperature, it can be ensured that the coating will remain fixated within the drinking straw.

According to yet another preferred embodiment, the coating contains between 0.2 and 20 wt. % of an emulsifier selected from the group consisting of polysorbates, phospholipids, monoglycerides, diglycerides, lactic acid esterified monoglyceride, diacetyl tartaric acid esterified monoglyceride, citric acid esterified monoglyceride, acetic acid esterified monoglyceride, polysorbate esterified triglyceride, fatty acid salts, sucrose esters of fatty acids and combinations thereof. According to an even more preferred embodiment, the coating contains at least 0.5 wt. %, most preferably at least 1 wt. % of the emulsifier. The use of such an emulsifier offers the advantage that it favours emulsification of the lipid material, thereby ensuring that no fat residue, or materials entrained therein, are retained within the drinking straw after usage.

In order to ensure that the iron component contained in the coating is rapidly released there from when it comes into contact with the liquid product, it is beneficial to incorporate into said coating one or more hydratable ingredients. Preferably said one or more hydratable ingredients are selected from sugars, starches, gums and water soluble edible polymers. Examples of suitable water soluble polymers are given in the following table:

| Gel | Solution |
|---|---|
| Agar | Starches (oxidized) + (OSA) |
| Carrageenans (trappa + iota) | Lambda |
| Starch | Gum Arabic |
| Maltodextrin (DE < 2) | Maltodextrin (DE > 20) |
| Gelatin | Galactomannans |
| Gellan | Xanthan |
| Pectins | Pectins |
| Alginate | Milk proteins |
| Curdlan | Cellulose (MC; CMC, MCC; |
| | HPMC) |
| B-glucan | B-Glucan |
| Inulin | Inulin |
| | Konjac mannan |
| | Dextran |

Particularly preferred hydratable ingredients include sugars (monosaccharides and/or disaccharides) and gums. Most preferably, the one or more hydratable ingredients are selected from the group consisting of sucrose and gum Arabic.

The amount of hydratable ingredients contained in the coating typically is within the range of 2-85 wt. % (e.g. 20-85 wt. %) and preferably within the range of 5-85 wt,% and especially preferred in the range of 5-50 wt. %. In addition, the combination of one or more hydratable ingredients, lipid material and iron preferably represents at least 70 wt. %, more preferably represents at least 85 wt. % of the coating on the inner surface of the drinking straw.

### The Drinking Straw

The drinking straw may be formed of any suitable material, for example from a paper based source, optionally protected on the interior and/or exterior surface thereof with a water resistant coating, e.g. of a polymer material. Alternatively, the straw may be formed substantially totally of a polymer material, e.g. by an extrusion process. Preferably, the straw is packaged to protect it from moisture and oxygen.

The iron component to be disposed inside the straw may be coated on all or part of the inner surface thereof. This can be achieved, for instance, by co-extruding the coating material together with the drinking straw. A suitable co-extrusion method for coating the interior of a drinking straw is described in U.S. Pat. No. 7,014,808 which is incorporated herein by reference. Additionally or alternatively, the material may be supported on one or more inserts (carrier) members inside the straw, e.g. of a liquid porous material or a honeycomb material, such as described in US-A-5 094 861.

Methods of manufacturing such a drinking straw constitute other aspects of the present invention. When the relevant material is coated on all or part of the inner surface, the method comprises allowing a coating composition comprising the relevant material to contact all or part of the inner surface and causing it to harden, e.g. by drying and/or curing. Additionally or alternatively, when one or more insert members are employed, the method comprises inserting one or more insert members inside the straw, the insert member(s) either being pre-impregnated with a composition (liquid or solid) comprising the relevant material or the insert member(s) or are impregnated in situ, inside the straw, e.g. by running a liquid composition containing the relevant material there through and optionally, causing it to harden, e.g. by drying and/or curing.

Thus, for example, as mentioned above, the coating composition on the inside of the straw may be coated over all or part of the inner surface of the straw. It may simply be coated by providing an aqueous suspension and/or dispersion of the components of the composition, to be disposed inside the straw, allowing the solution or dispersion to coat the inside of the straw and allowing the solution and/or dispersion to dry. However, it is also possible to enhance adhesion of the composition to the inner surface of the straw by providing in the composition, one or more hydratable ingredients such as sugars, starches, gums (such as gum-Arabic or guar gum) and water soluble edible polymers.

Preferably, the amount of such hydratable ingredient(s) in the solution and/or dispersion is from 0.001 to 20%, more preferably from 0.01% to 10% by weight of that solution and/or dispersion. The amount of water in the solution and/or dispersion is preferably from 90% to 99.99%, more preferably from 80% to 99% by weight of the solution and/or dispersion.

A particularly advantageous aspect of the present invention relates to a method of preparing a drinking straw comprising a hollow elongate tube through which liquid may be drawn by suction, the tube having an outer surface and an inner surface, wherein an iron component is disposed inside the drinking straw, said method comprising:
providing an emulsion containing:
   20-90 wt. % water;
   0.5-40 wt. % lipid material;
   3-40 wt. % of one or more hydratable ingredients selected from sugars, starches, gums, water soluble edible polymers and mixtures thereof; and
   0.5-12 wt. % of iron;
delivering said emulsion to the inner surface of the drinking straw; and
drying the emulsion to fixate the dried emulsion onto the inner surface of the drinking straw.

The straws obtained through this method offer the advantage that the coating containing the iron component sticks well to the inner surface of the drinking straw. At the same time, said iron component is quickly released from said coating when an aqueous liquid passes through the drinking straw.

The drying of the emulsion after delivery to the inner surface of the drinking straw may suitably be achieved by air drying, vacuum drying, freeze drying or combinations of these drying techniques.

It is particularly convenient to provide the drinking straw in direct conjunction with a container containing the liquid food product or beverage to be consumed through the straw. The straw may be provided loose alongside the container, packaged together with it, for example in an outer wrap such as a transparent or semi-transparent seal or adhered to the outside of the container, e.g. using a wax or breakable adhesive. In any of these arrangements, optionally the straw may be packaged in its own pack such as a plastics sleeve. The beverage container itself may be of any suitable material such as waxed and/or metallised paper or card, plastics, glass, metal (such as aluminium) or the like.

When the straw is used in conjunction with a liquid food, the liquid food may, for example be a soup or liquid slimming aid food.

Suitable beverages may be chosen from a very wide range, for example selected from water, flavoured water, tea, iced tea, coffee, iced coffee, fruit juice, fruit squash, milk, flavoured milk drink, yoghurt, yoghurt drink, flavoured yoghurt drink, cola or any other non-alcoholic carbonated or non-carbonated drink, “energy drink” or soy based beverage (flavoured or unflavoured).

The present invention will now be explained in more detail by way of the following non-limiting examples.

### EXAMPLES

### Example 1

Coating emulsion were prepared on the basis of the following recipes:

| Emulsion | Composition | |
|---|---|---|
| 1 | 29.9 | wt. % FeSO₄•7H₂O |
| | 20 | wt. % sucrose |
| | 5 | wt. % hydrogenated palm oil |
| | | (PO48) |
| | 2 | wt. % Tween ® 80 |
| 2 | 29.9 | wt. % FeSO₄•7H₂O |
| | 20 | wt. % sucrose |
| | 1 | wt. % hydrogenated palm oil |
| | | (PO48) |
| | 0.4 | wt. % Tween ® 80 |
| 3 | 29.9 | wt. % FeSO₄•7H₂O |
| | 20 | wt. % sucrose |
| | 5 | wt. % hydrogenated palm oil |
| | | (PO48) |
| | 5 | wt. % Tween ® 80 |
| 4 | 29.9 | wt. % FeSO₄•7H₂O |
| | 30 | wt. % sucrose |
| | 5 | wt. % hydrogenated palm oil |
| | | (PO48) |
| | 2 | wt. % Tween ® 80 |
| 5 | 29.9 | wt. % FeSO₄•7H₂O |
| | 20 | wt. % sucrose |
| | 5 | wt. % hydrogenated palm oil |
| | | (PO48) |
| | 2 | wt. % gum Arabic |

The coating compositions were prepared by mixing together the ingredients at a temperature above the melting point of the hydrogenated palm oil. Next, the emulsion was homogenised for 30 seconds using an Ultraturrax T25 (IKA Werke, Staufe, Germany).

100 μl of each coating composition (containing 6 mg of iron) was introduced in a drinking straw, following which the drinking straws were dried at 40° C. in an open oven.

The coated drinking straws so obtained were tested by placing them in a vertical position and flushing multiple times with 10 ml distilled water, mimicking the drinking of a beverage via a drinking straw. The results obtained showed that the coatings had completely dissolved before 280 ml of distilled water had been passed there through.

### Example 2

High density polyethylene (HDPE) drinking straws had passed there through, a liquid composition comprising a saturated solution of FeSO₄ at 25° C.

The individual straws were then air-blown with warm air at 40° C. until the composition had dried on the inside of the straw, leaving a free passage there through. The straws were then packaged in transparent low density polyethylene (LDPE) sleeves. These sleeved straws were then adhered to the outside of metallised card containers with straw-piercable foil seals, the containers being filled with the following beverage composition:—

| | Drink:Neutral % | Acid % |
|---|---|---|
| Skim milk powder MH | 6.27 | 6.27 |
| Triglyceride oil | 2.64 | 2.64 |
| (including PUFAs) | | |
| Sucrose | 1.59 | 1.61 |
| Maltodextrin | 7.09 | 5.64 |
| k-carrageenan | 0.020 | — |
| Stabiliser | — | 1.45 |
| Water2 | — | 22.50 |
| Water3 | 0.25 | 0.25 |
| Vitamin/mineral premix | 0.65 | 0.65 |
| (without Fe) | | |
| Lactic acid | — | 1.50 |
| Annatto extract AS1 | — | 0.135 |
| Peach flavour | — | 0.039 |
| Water | balance | balance |

In the light of the described examples, modifications of those examples, as well as other examples, all within the scope of the present invention as indicated by the appended claims will now become apparent to persons skilled in the art.

1. A combination of a container in which is disposed a liquid composition in the form of a beverage or liquid food and a drinking straw comprising a hollow elongate tube through which liquid may be drawn by suction, the tube having an outer surface and an inner surface, the combination further comprising an iron component disposed inside the drinking straw and an oxidisable oil comprising one or more polyunsaturated fatty acids disposed in the liquid composition.

2. A combination according to claim 1, wherein between 1 and 20 mg, preferably between 2 and 12 mg of iron is disposed inside the drinking straw.

3. A combination according to claim 2, wherein between 1 and 60 mg of the iron component is disposed inside the drinking straw.

4. A combination according to claim 3, wherein the component disposed inside the drinking straw is coated on the inner surface thereof.

5. A combination according to claim 4, wherein the coating on the inner surface contains at least 3 wt. %, preferably at least 6 wt. % of iron.

6. A combination according to claim 4, wherein the coating on the inner surface contains at least 0.5 wt. % of lipid material.

7. (canceled)

8. A combination according to claim 6, wherein the lipid material has an iodine value of less than 30 and a melting point of at least 30° C.

9. A combination according to claim 4, wherein the coating on the inner surface contains between 0.2 and 20 wt. % of an emulsifier selected from polysorbate, phospholipids, monoglycerides, diglycerides, lactic acid esterified monoglyceride, diacetyl tartaric acid esterified monoglyceride, citric acid esterified monoglyceride, acetic acid esterified monoglyceride, polysorbate esterified triglyceride, fatty acid salts, sucrose esters of fatty acids and combinations thereof.

10. A combination according to claim 4, wherein the coating on the inner surface further comprises one or more hydratable ingredients selected from sugars, starches, gums, water soluble edible polymers and mixtures thereof.

11. (canceled)

12. (canceled)

13. A combination according to claim 1, wherein the component disposed inside the drinking straw is carried on a carrier member.

14. A combination according to claim 1, wherein the iron component comprises iron II sulphate, iron fumarate, iron III sulphate, iron pyrophosphate, iron lactate, iron citrate, iron ammonium citrate, iron ammonium sulphate, iron saccharate, iron glucomate, iron succinate, iron complexed with EDTA and mixtures thereof.

15. A combination according to claim 1, wherein the oxidisable oil comprises one or more long chain polyunsaturated acids.

16. A combination according to claim 1, wherein the liquid composition is an oil-in-water emulsion containing 0.5-20 wt. % of oxidisable oil.

17. A drinking straw comprising a hollow elongate tube through which liquid may be drawn by suction, the tube having an outer surface and an inner surface, wherein an iron component is disposed inside the drinking straw.

18. A drinking straw according to claim 17, wherein the component disposed inside the drinking straw is coated on the inner surface thereof.

19. A drinking straw according to claim 17, wherein between 1 and 20 mg, preferably between 2 and 12 mg of iron is disposed inside the drinking straw.

20. A drinking straw according to claim 18, wherein the coating on the inner surface contains at least 3 wt. %, preferably at least 6 wt. % of iron.

21. A drinking straw according to claim 18, wherein the coating on the inner surface contains at least 0.5 wt. % of lipid material.

22. A drinking straw according to claim 21, wherein the lipid material is selected from the group consisting of triglycerides, waxes and fatty acid emulsifiers and combinations thereof.

23. A combination according to claim 21 or 22, wherein the lipid material has an iodine value of less than 30 and a melting point of at least 30° C.

24. A drinking straw according to claim 18, wherein the coating on the inner surface contains between 0.2 and 20 wt. % of an emulsifier selected from polysorbate, phospholipids, monoglycerides, diglycerides, lactic acid esterified monoglyceride, diacetyl tartaric acid esterified monoglyceride, citric acid esterified monoglyceride, acetic acid esterified monoglyceride, polysorbate esterified triglyceride, fatty acid salts, sucrose esters of fatty acids and combinations thereof.

25. A drinking straw according to claim 18, wherein the coating on the inner surface further comprises one or more hydratable ingredients selected from sugars, starches, gums, water soluble edible polymers and mixtures thereof.

26. A drinking straw according to claim 17, wherein between 1 and 60 mg of the iron component is disposed inside the drinking straw.

27. A drinking straw according to claim 17, in which an iron component is disposed, the iron component comprising iron II sulphate, iron fumarate, iron III sulphate, iron pyrophosphate, iron lactate, iron citrate, iron ammonium citrate, iron ammonium sulphate, iron saccharate, iron gluconate, iron succinate, iron complexed with EDTA and mixtures thereof.

28. A method of preparing a drinking straw comprising a hollow elongate tube through which liquid may be drawn by suction, the tube having an outer surface and an inner surface, wherein an iron component is disposed inside the drinking straw, said method comprising:
providing an emulsion containing:
20-90 wt % water;
0.5-40 wt. % lipid material;
3-40 wt. % of one or more hydratable ingredients selected from sugars, starches, gums, water soluble edible polymers and mixtures thereof; and
0.5-12 wt. % of iron;
delivering said emulsion to the inner surface of the drinking straw; and
drying the emulsion to fixate the dried emulsion onto the inner surface of the drinking straw.
